(19) United States
(12) Patent Application Publication
(10) Pub. No.: US 2026/0141512 A1
(43) Pub. Date: May 21, 2026

(54) DETERMINING AN OCCLUSION STATUS FOR MICROFLUIDIC CHANNELS USING DIGITAL HOLOGRAPHY

(71) Applicant: Honeywell International Inc., Charlotte, NC (US)

(72) Inventors: Andy Walker Brown, Richardson, TX (US); Domenico Morales Ortiz, Mexico City (MX); Peer Mohamed Shafeeq Shajudeen, Anna, TX (US)

(21) Appl. No.: 18/950,342

(22) Filed: Nov. 18, 2024

(51) Int. Cl. G06T 7/00; G06T 7/20

(52) U.S. Cl. CPC G06T 7/0012; G06T 7/20; G06T 2207/10056; G06T 2207/30104

(57) ABSTRACT

Various embodiments described herein relate to determining flow occlusion in microfluidics using digital holography. In this regard, various embodiments provide for receiving two or more images of a plurality of blood cells transiting one or more microfluidic channels of an occlusion device, determining a presence indication for blood cells within the one or more microfluidic channels based on at least one image of the two or more images, determining a movement indication for the blood cells within the one or more microfluidic channels based on the two or more images, and generating an occlusion status for the one or more microfluidic channels based on the presence indication and the movement indication.

### TECHNOLOGICAL FIELD

Example embodiments of the present disclosure relate generally to image processing techniques related to a diagnostic device, and more particularly, to image processing techniques related to digital holography imagery.

### BACKGROUND

Microscopic imaging techniques may be utilized to generate diagnostic images. However, diagnostic images provided via microscopic imaging techniques are susceptible to technical challenges and/or limitations for certain types of diagnostic device applications such as, for example, diagnostic device applications related to hematologic diseases.

### BRIEF SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an embodiment, an apparatus comprises one or more processors and one or more storage devices storing instructions that are operable, when executed by the one or more processors, to cause the one or more processors to receive two or more images of a plurality of blood cells transiting one or more microfluidic channels of an occlusion device. In one or more embodiments, the one or more storage devices store instructions are operable, when executed by the one or more processors, to additionally or alternatively cause the one or more processors to determine a presence indication for blood cells within the one or more microfluidic channels based on at least one image of the two or more images. In one or more embodiments, the one or more storage devices store instructions are operable, when executed by the one or more processors, to additionally or alternatively cause the one or more processors to determine a movement indication for the blood cells within the one or more microfluidic channels based on the two or more images. In one or more embodiments, the one or more storage devices store instructions are operable, when executed by the one or more processors, to additionally or alternatively cause the one or more processors to generate an occlusion status for the one or more microfluidic channels based on (i) the presence indication and (ii) the movement indication. In one or more embodiments, the occlusion status quantifies occlusions formed within the one or more microfluidic channels.

In another embodiment, a computer-implemented method is provided. In one or more embodiments, the computer-implemented method includes receiving two or more images of a plurality of blood cells transiting one or more microfluidic channels of an occlusion device. In one or more embodiments, the computer-implemented method additionally or alternatively includes determining a presence indication for blood cells within the one or more microfluidic channels based on at least one image of the two or more images. In one or more embodiments, the computer-implemented method additionally or alternatively includes determining a movement indication for the blood cells within the one or more microfluidic channels based on the two or more images. In one or more embodiments, the computer-implemented method additionally or alternatively includes generating an occlusion status for the one or more microfluidic channels based on (i) the presence indication and (ii) the movement indication. In one or more embodiments, the occlusion status quantifies occlusions formed within the one or more microfluidic channels.

In yet another embodiment, a computer program product is provided. The computer program product comprises at least one non-transitory computer readable storage medium having computer executable code portions stored therein. In one or more embodiments, the computer executable code portions comprise program code instructions configured to receive two or more images of a plurality of blood cells transiting one or more microfluidic channels of an occlusion device. In one or more embodiments, the program code instructions are additionally or alternatively configured to determine a presence indication for blood cells within the one or more microfluidic channels based on at least one image of the two or more images. In one or more embodiments, the program code instructions are additionally or alternatively configured to determine a movement indication for the blood cells within the one or more microfluidic channels based on the two or more images. In one or more embodiments, the program code instructions are additionally or alternatively configured to generate an occlusion status for the one or more microfluidic channels based on (i) the presence indication and (ii) the movement indication, wherein the occlusion status quantifies occlusions formed within the one or more microfluidic channels.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a block diagram of an exemplary system for determining flow occlusion in microfluidics using digital holography in accordance with one or more embodiments of the present disclosure;

FIG. 2 illustrates a block diagram of another exemplary system for determining flow occlusion in microfluidics using digital holography in accordance with one or more embodiments of the present disclosure;

FIG. 3 illustrates an exemplary data flow for determining flow occlusion in microfluidics using digital holography in accordance with one or more embodiments of the present disclosure;

FIG. 4A illustrates the exemplary occlusion device with the one or more microfluidic channels having multiple dimensions at various points in accordance with one or more embodiments of the present disclosure;

FIG. 4B illustrates an enlarged view of the exemplary occlusion device with the one or more microfluidic channels having multiple dimensions at various points in accordance with one or more embodiments of the present disclosure;

FIG. 4C illustrates an example of microscopy images of a normal blood sample and a hematologic sample occluded within the one or more microfluidic channels in accordance with one or more embodiments of the present disclosure;

FIG. 5 illustrates an example holographic microscopy image with blood sample cells flowing from an inlet to an outlet of the one or more microfluidic channels in accordance with one or more embodiments of the present disclosure;

FIG. 6 illustrates an example system depicting an example apparatus in accordance with one or more embodiments of the present disclosure;

FIG. 7 illustrates a flowchart of a method for determining flow occlusion in microfluidics using digital holography in accordance with one or more embodiments of the present disclosure;

FIG. 8 illustrates an exemplary data flow for determining an intensity measure associated with blood cell presence identification in accordance with one or more embodiments of the present disclosure; and

FIG. 9 illustrates an exemplary data flow for determining a correlation coefficient associated with movement identification in accordance with one or more embodiments of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

Hematologic diseases such as Sickle Cell Disease (SCD) require early diagnosis and constant monitoring and treatment throughout a patient's lifespan. About 3 million people worldwide suffer from the SCD, mostly in Africa, India and the Middle East, with an estimated 100,000 affected in the U.S., according to the Centers for Disease Control and Prevention. SCD affects 1 in 375 African American newborns born in the U.S. Early diagnosis through newborn screening, followed by simple interventions, has dramatically reduced SCD related mortality in the US. More than 800 children are born with SCD every day in Africa, and more than half of the children die in childhood due to lack of diagnosis and early treatment. Effective treatment of SCD still remains a challenge in preventing childhood and adult mortality, especially in the developing world due to requirements of skilled individuals and the high cost of currently available modalities. Frequent SCD severity monitoring presents insurmountable challenges due to a lack of objective measures of the disease state and the reliance on highly subjective patient-reported symptoms like pain. For example, microscopic imaging techniques may be utilized to generate diagnostic images using an optical microscope. The diagnostic images may be utilized to determine morphological characteristics of blood cells (e.g., red blood cells). However, diagnostic images provided via microscopic imaging techniques are susceptible to technical challenges and/or limitations for providing monitoring and/or insights related to SCD or other types of hematologic diseases since, for example, the diagnostic images do not account for complex and/or dynamic intravascular interactions of blood cells and/or blood components.

To address these and/or other issues related to traditional imaging techniques, one or more embodiments disclosed herein provide for determining flow occlusion in microfluidics using digital holography. For example, image processing can be provided to assess an occlusion status of blood cells perfused through microfluidic channels imaged with digital holographic microscopy. The microfluidic channels can simulate blood vessels (e.g., microvasculature blood vessels) of a human body. As such, accurate identification and/or measurement of blood flow occlusions can be provided. In some embodiments, the digital holography techniques disclosed herein may be utilized to monitor for SCD and/or another type of hematologic disease. In some embodiments, by determining flow occlusion in microfluidics using digital holography, improved assessment of SCD severity or other blood clotting disorders (e.g., hemophilia, patients needing blood thinners, etc.) can be provided by eliminating the need for subjective interpretation of images via manual inspection or semi-automated analysis techniques. In addition to enabling improved monitoring and treatment of SCD patients, efficacy of medical treatments can be accurately predicted.

In one or more embodiments, one or more digital holography images associated with one or more microfluidic channels can be captured. For example, an occlusion device can include one or more microfluidic channels with a predefined cross-sectional area. The one or more microfluidic channels can be configured to allow flow of a plurality of blood cells of a blood sample within an interior surface of the one or more microfluidic channels. Additionally, at least one image can be configured to generate the one or more digital holography images of the plurality of blood cells transiting the one or more microfluidic channels. In one or more embodiments, a processor coupled to the at least one imager can be configured to receive the one or more digital holography images to facilitate determining flow occlusion in the one or more microfluidic channels using digital holography. In some embodiments, the one or more digital holography images can be reconstructed and/or computationally focused to facilitate further image processing related to determining flow occlusion in the one or more microfluidic channels. For example, an amplitude image and/or a phase image for each digital holography image can be generated. In some embodiments, pre-processing can be applied to the one or more digital holography images. For example, the one or more digital holography images can be rotated for alignment with respect to a predefined axis. Additionally or alternatively, the one or more digital holography images can be cropped to focus on relevant microfluidic channels. Additionally or alternatively, relevant microfluidic channels of the one or more digital holography images can be localized. Additionally or alternatively, the one or more digital holography images can be normalized and/or brightness of one or more portions of the one or more digital holography images can be adjusted.

After being reconstructed, computationally focused, and/or pre-processed, the one or more digital holography images can be analyzed to assess each microfluidic channel. In some embodiments, presence of blood cells in the one or more digital holography images can be identified based on how bright or dark a microfluidic channel appears in the one or more digital holography images. In some embodiments, a defined threshold can be utilized to determine how bright or dark a microfluidic channel appears in the one or more digital holography images. In some embodiments, movement in the one or more digital holography images can be determined. For example, movement can be determined based on how the one or more digital holography images change from one image frame to a successive image frame. In some embodiments, movement in the one or more digital holography images can be determined based on a frame-to-frame correlation coefficient image generated using a sliding window (e.g., a 5×5 pixel sliding window) followed by calculating a global average per resulting image. Additionally, the global average can be compared to a defined threshold. Based on the analysis of the one or more digital holography images, an occlusion status for each microfluidic channel can be determined. In some embodiments, an occlusion status for each microfluidic channel can be determined based on a defined threshold related to the presence of blood cells and/or a defined threshold related to the movement. In some embodiments, a report related to a health status of a patient associated with the occlusion device can be generated to show severity of a hematologic disease (e.g., SCD, etc.) in the plurality of blood cells transiting the one or more microfluidic channels.

In some embodiments, two or more images of a plurality of blood cells transiting one or more microfluidic channels of an occlusion device are received, a presence indication for blood cells within the one or more microfluidic channels is determined based on at least one image of the two or more images, a movement indication for the blood cells within the one or more microfluidic channels is determined based on the two or more images, and an occlusion status for the one or more microfluidic channels is determined based on the presence indication and the movement indication. The occlusion status may quantify and/or characterize occlusions formed within the one or more microfluidic channels.

In some embodiments, blood cells are perfused through one or more microfluidic channels that are comparable in dimension and/or cross-sectional area to microvasculature blood vessels. Additionally, two or more subsequent images can be acquired during the perfusion process with respect to the one or more microfluidic channels. In some embodiments, an occlusion status for the one or more microfluidic channels can be generated based on the two or more subsequent images. In some embodiments, the occlusion status for the one or more microfluidic channels can be generated based on a first determination of cell presence within each microfluidic channel captured in at least one image of the two or more subsequent images, and/or a second determination of cell movement within each microfluidic channel captured in the two or more subsequent images.

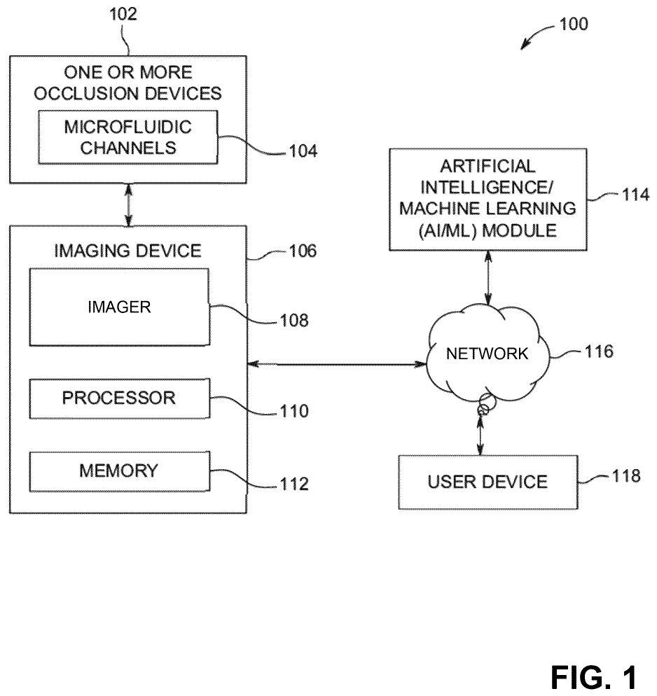

FIG. 1 illustrates a block diagram of a system 100 for determining flow occlusion in microfluidics using digital holography, in accordance with an example embodiment of the present disclosure. The system 100 includes an occlusion device 102 and an imaging device 106. The occlusion device 102 includes one or more microfluidic channels 104. The imaging device 106 may comprise at least one imager 108 and at least one processor 110 operated on stored instructions in a memory 112. In some embodiments, the at least one imager 108 can be a digital holographic imager. The one or more microfluidic channels 104 may have a predefined cross-sectional area. Further, the predefined cross-sectional area of the one or more microfluidic channels 104 may correspond to cross-sectional area of small blood vessels (not shown). The one or more microfluidic channels 104 may be configured to allow flow of a plurality of blood cells of a blood sample within an interior surface (not shown) of the one or more microfluidic channels 104. In some embodiments, the interior surface of the one or more microfluidic channels 104 may be coated with a plurality of endothelial cells. In some other embodiments, the interior surface of the one or more microfluidic channels 104 may be coated using Laminin or p-selectin. In some example embodiments, various other coating options may exist depending on which pharma medication is being evaluated for efficacy, without departing from the scope of the disclosure. Hereinafter, the occlusion device 102 and one or more occlusion devices 102 may be used interchangeably.

In some embodiments, the at least one imager 108 may be configured to generate one or more digital holography images or videos of the plurality of blood cells transiting the one or more microfluidic channels 104. The at least one imager 108 may be referred to as a digital holographic imager. In some embodiments, the at least one imager 108 may use a lensless in-line digital holography configuration to generate the one or more digital holography images or videos. In some embodiments, the at least one processor 110 may utilize angular spectrum propagation for modelling the propagation of a wave field to generate the one or more digital holography images or videos. It may be noted that the angular spectrum propagation may be configured to computationally focus the one or more digital holography images or videos, without departing from the scope of the disclosure.

The at least one processor 110 may be operationally coupled to the at least one imager 108. The at least one processor 110 may be configured to receive the one or more digital holography images or videos. The at least one processor 110 may be configured to analyze the generated one or more digital holography images or videos to determine severity of the hematologic disease. In some embodiments, the hematologic disease may correspond to diseases relating to blood cells such as, RBCs, leukocytes, platelets, etc. In some embodiments, the hematologic disease may correspond to sickle cell disease.

In some embodiments, the at least one processor 110 may include suitable logic, circuitry, and/or interfaces that are operable to execute one or more instructions stored in a memory 112 to perform predetermined operations. In one embodiment, the at least one processor 110 may be configured to decode and execute any instructions received from one or more other electronic devices or server(s). The at least one processor 110 may be configured to execute one or more computer-readable program instructions, such as program instructions to carry out any of the functions described in this description. Further, the processor may be implemented using one or more processor technologies known in the art. Examples of the processor include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

Further, the memory 112 may be communicatively coupled to the at least one processor 110. In some embodiments, the memory 112 may be configured to store a set of instructions and data executed by the at least one processor 110. Further, the memory 112 may include the one or more instructions that are executable by the at least one processor 110 to perform specific operations. It is apparent to one skilled in the art that the one or more instructions stored in the memory 112 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

Further, the system 100 may comprise an Artificial Intelligence/Machine Learning (AI/ML) module 114 communicatively coupled to the at least one processor 110, via a network 116. The AI/ML module 114 may utilize AI and/ML to analyze one or more digital holography images or videos. However, it is to be appreciated that, in some embodiments, the AI/ML module 114 may analyze one or more digital holography images or videos without utilizing AI and/or ML. For example, in some embodiments, the AI/ML module 114 may utilize one or more computer vision techniques to analyze one or more digital holography images or videos. In some embodiments, the at least one processor 110 and/or the AI/ML module 114 may analyze the generated one or more digital holography images or videos to quantify and/or characterize one or more occlusions formed within the one or more microfluidic channels 104. In various embodiments, the quantification and/or characterization may be performed by determining a percentage of occluded channels at some point of time during perfusion and a rate at which the one or more microfluidic channels 104 may be occluded. Such quantification and/or characterization of the occlusions within the one or more microfluidic channels 104 may be configured to generate a score or relative indicator of a health status of a subject (e.g., a patient, etc.). The score or relative indicator may additionally or alternatively indicate an efficacy of a medical treatment of the subject based on a severity of the hematologic disease in the plurality of blood cells. In some embodiments, the AI/ML module 114 may be configured to detect and classify individual cells and/or groups of cells. The classification may ensure that the detected cells are the plurality of blood cells and not some other noise or dust/debris. In some alternate embodiments, the AI/ML module 114 may be integrated within the at least one processor 110 to analyze the generated one or more digital holography images or videos without the need for remotely monitoring via the network 116. In some embodiments, the AI/ML module 114 may segregate the blood cells from other elements present in the image.

In some embodiments, the network 116 may facilitate a communication link between the AI/ML module 114 and the at least one processor 110. It may be noted that the network 116 may be referred as a network interface that facilitates a communication link among the other components of the system 100. Further, the network 116 may be a wireless network and/or a wired network. The network 116 may be implemented using one or more communication techniques. The one or more communication techniques may be Radio waves, Wi-Fi, Bluetooth, ZigBee, Z-wave and other communication techniques, known in the art.

In some embodiments, the AI/ML module 114 may be communicatively coupled to and/or integrated within a cloud computing platform that uses one or more machine learning models and/or visual analytics to deliver intelligent actionable insights related to the occlusion device 102. The cloud computing platform may be an extensible platform that is portable for deployment in any cloud or data center environment for providing the intelligent actionable insights related to the occlusion device 102.

In some embodiments, the cloud computing platform may include one or more computer systems connecting network-connected devices. The one or more computer systems of the cloud computing platform may include any type or quantity of one or more processors and one or more data storage devices comprising memory for storing and executing applications or software modules of a networked computing system environment. In one embodiment, the processors and data storage devices are embodied in server-class hardware, such as enterprise-level servers. For example, in an embodiment, the processors and data storage devices comprise any type or combination of application servers, communication servers, web servers, super-computing servers, database servers, file servers, mail servers, proxy servers, and/virtual servers. Further, the one or more processors are configured to access the memory and execute processor-readable instructions, which when executed by the processors configures the processors to perform a plurality of functions of a networked computing system environment. In some embodiments, the at least one imaging device 106 may be an edge device of the cloud computing platform.

In some embodiments, the system 100 further includes at least one user device 118. The at least one user device 118 may be configured to receive the quantified occlusion of the plurality of blood cells to display a report related to a health status of a subject (e.g., a patient, etc.). The at least one user device 118 may be wired to the at least one processor 110 or may be coupled, via the network 116. In some embodiments, the at least one user device 118 may include a wired or wireless devices operationally coupled to the system 100. For example, the at least one user device 118 may be a desktop or laptop computer, a tablet, smart phone, a wearable device, a virtual reality device, an augmented reality device, or other type of user device.

Further, the system 100 may include an input/output circuitry (not shown) that may enable a user to communicate or interface with the system 100 via the at least one user device 118. In some example embodiments, the at least one user device 118 may include a control room computer system or other portable electronic devices. It may be noted that the input/output circuitry may act as a medium transmit input from the at least one user device 118 to and from the system 100. In some embodiments, the input/output circuitry may refer to the hardware and software components that facilitate the exchange of information between the user and the system 100. In one example, the system 100 may include a graphical user interface (GUI) (not shown) as an input circuitry to allow the user to input data via the at least one user device 118. The input/output circuitry may include various input devices such as keyboards, barcode scanners, GUI for the user to provide data and various output devices such as displays, printers for the user to receive data. In another example, the input/output circuitry may include various output circuitry such as indicators to indicate the correct and incorrect placement of the occlusion device 102.

In some alternate embodiments, the system 100 may include a communication circuitry (not shown). The communication circuitry may allow the imaging device 106 and the at least one user device 118 to exchange data or information with other systems. Further, the communication circuitry may include network interfaces, protocols, and software modules responsible for sending and receiving data or information. In some embodiments, the communication circuitry may include Ethernet ports, Wi-Fi adapters, or communication protocols like HTTP or MQTT for connecting with other systems.

It will be apparent to one skilled in the art the above-mentioned components of the system 100 have been provided only for illustration purposes. In some embodiments, the system 100 may include other components as well, without departing from the scope of the disclosure.

In some embodiments, the at least one imager 108 may be configured to generate the one or more digital holography images or videos of the occluded channels in the one or more microfluidic channels 104. Further, the at least one imager 108 may be referred to as a digital holographic imager. In some embodiments, the at least one imager 108 may use a lensless in-line digital holography configuration to generate the one or more digital holography images or videos.

In some embodiments, the imaging device 106 may comprise an illumination source. The illumination source may be directed towards the one or more microfluidic channels 104. The illumination source may be configured to facilitate the at least one imager 108 to generate the one or more digital holography images or videos. In some embodiments, the illumination source may comprise a height adjustable light tube and/or a laser driver that may be installed above the at least one imager 108. The height adjustable light tube may be a telescopic structure with adjustment of height from the one or more microfluidic channels 104 placed on a cross hair of a housing of the imaging device 106.

In some embodiments, the at least one processor 110 may be communicatively coupled to one or more components of the at least one imager 108. In some embodiments, the at least one processor 110 may be configured to receive the one or more digital holography images or videos. Further, the at least one processor 110 may analyze the generated one or more digital holography images or videos to quantify and/or characterize one or more occluded channels within the one or more microfluidic channels 104. In one example embodiment, the occluded channels may be quantified and/or characterized to generate a score or relative indicator of the health status and indicate the efficacy of a medical treatment of the subject based on the severity of the hematologic disease. It may be noted that the subject herein may refer to a patient or a person having a medical condition. In one example embodiment, the score or relative indicator may include one or more reference ranges to allow for quick indication of the severity of the hematologic disease. In some embodiments, the score may include one or more reference ranges to allow for quick indication of the severity of a sickle cell disease (SCD).

In some embodiments, the at least one processor 110 may be configured to analyze the generated one or more digital holography images or videos using the AI/ML module 114. In some embodiments, the generated one or more digital holography images or videos may be analyzed to count the occluded channels within the one or more microfluidic channels 104. It may be noted that the count indicates the severity of the hematologic disease in the plurality of blood cells.

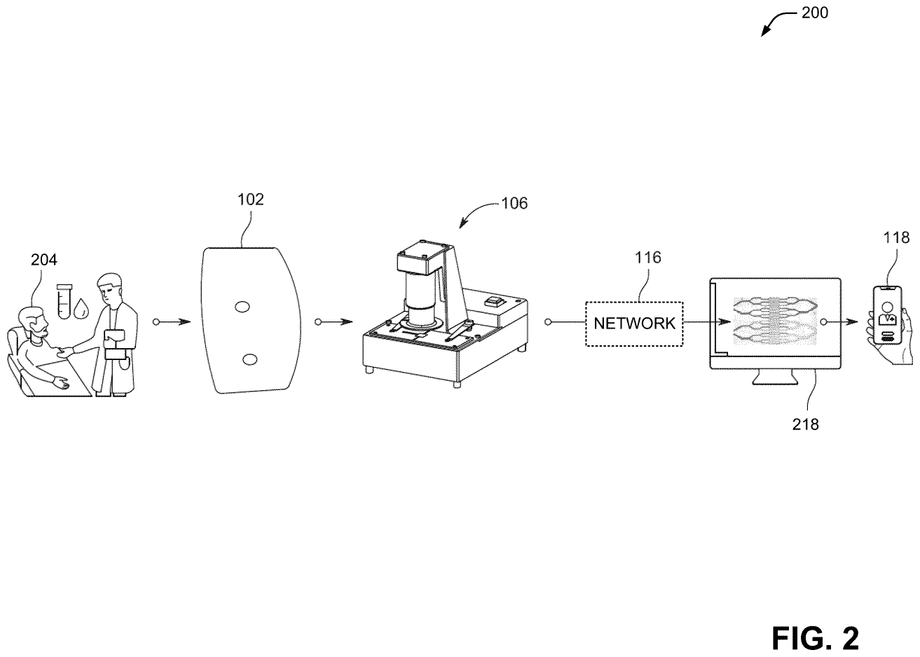

FIG. 2 illustrates an exemplary system 200 for determining flow occlusion in microfluidics using digital holography, in accordance with an example embodiment of the present disclosure. The system 200 includes the occlusion device 102, the imaging device 106, the network 116, and the at least one user device 118.

In some embodiments, the at least one user device 118 that may be configured to receive the quantified occlusion of the plurality of blood cells to display a report on the at least one user device 118 related to a health status of a subject 204. Further, the report may be displayed on a display device 218. In some embodiments, the display device 218 may be a display of the at least one user device 118. In other embodiments, the display device 218 may be a device that is communicatively coupled to the at least one user device 118. In one example, the subject 204 may receive the report in his/her user device, like the smartphone. In some embodiments, the report may comprise at least one score or relative indicator of a health status of the subject 204 and/or indicate an efficacy of a medical treatment of the subject 204 based on the severity of the hematologic disease in the plurality of blood cells. The system 100 may further transfer the report to the subject 204, via the network 116. In some embodiments, the AI/ML module 114 may be implemented over the network 116 to interpret the data of the report entailing the details of the health status of the subject 204.

As discussed above, the at least one processor 110 may be configured to analyze the generated one or more digital holography images or videos using AI/ML module 114. The AI/ML module 114 may be configured to count total occluded channels after the plurality of blood cells pass through the one or more microfluidic channels 104 of the occlusion device 102. The AI/ML module 114 may implement AI/ML algorithms to quantify occlusion formed within the one or more microfluidic channels 104. The AI/ML module 114 may count total number of locations, and temporal durations of occlusions in the one or more microfluidic channels 104 to determine severity of the hematologic disease.

In some embodiments, the total number of occluded channels may be a proxy measurement for the severity of the SCD. The quantification and/or characterization of the occluded microfluidic channels 104 may be configured to generate the score or relative indicator of the subject 204 health status and/or indicate an efficacy of the medical treatment of the subject 204 based on the severity of a hematologic disease in the plurality of blood cells.

In some embodiments, total number of occluded channels, location within a branched structure of the one or more microfluidic channels 104, and/or temporal duration of the occlusion may be proxy measurements for the severity of hematologic diseases such as, a sickle cell disease. It may be noted that the dynamic and interactive nature of the biophysical flow characteristics of all components of the blood sample may be evaluated. It may also be noted that the occlusion may be caused by combinations of cell stickiness/adhesion from the components of the blood sample (e.g., hemoglobin content, morphological changes, cell stiffness/deformability, and/or other parameters working together within the one or more microfluidic channels 104). It will be apparent to one skilled in the art that the one or more digital holography images or videos may be acquired one or more times to identify occlusions and characterize the occluded sample, to determine severity of the hematologic diseases.

The present disclosure utilizing microfluidic channels and a digital holography technique to determine severity of the hematologic diseases like sickle cell disease. In some embodiments, the microfluidic channels may be coated/functionalized in order to cause diseased blood cells to preferentially occlude the microfluidic channels. The images/videos are analyzed to quantify occlusion of the microfluidic channels. Therefore, a detailed report of severity of hematologic disease, such as sickle cell disease, is provided to the user remotely. The present disclosure also provides a benefit of not labelling the cells, that is, the cells are unstained and untagged. This provides a cost benefit of determining the severity of diseases without using fluorescent dyes for tagging the cells.

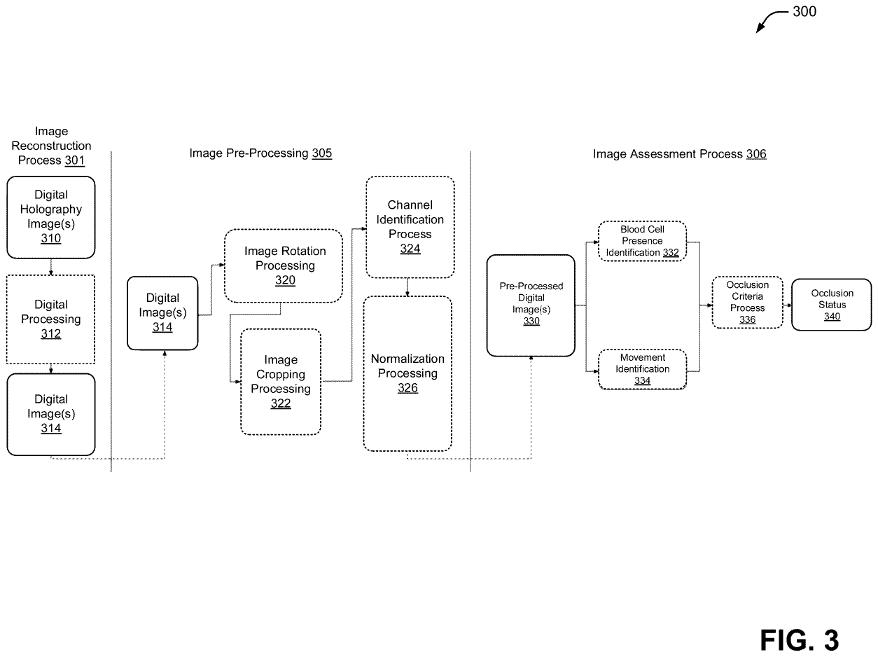

FIG. 3 illustrates an exemplary data flow 300 for determining flow occlusion in microfluidics using digital holography, in accordance with an example embodiment of the present disclosure. The data flow 300 includes an image reconstruction process 301, image pre-processing 305, and/or image assessment process 306. In one or more embodiments, the image reconstruction process 301 can utilize one or more digital holography images 310 to generate one or more digital images 314 for the image pre-processing 305, and/or the image assessment process 306. The one or more digital holography images 310 can be associated with a plurality of blood cells transiting the one or more microfluidic channels 104 of the occlusion device 102. The one or more digital images 314 can be utilized to facilitate determining flow occlusion in the one or more microfluidic channels 104. In some embodiments, the image reconstruction process 301 can perform digital processing 312 to generate the one or more digital images 314. For example, the one or more digital holography images 310 can be reconstructed and/or computationally focused via the digital processing 312. In some embodiments, the one or more digital images 314 can include an amplitude image and/or a phase image for each digital holography image of the one or more digital holography images 310.

In some embodiments, the image pre-processing 305 can be applied to the one or more digital images 314. For example, the one or more digital images 314 can be rotated for alignment with respect to a predefined axis via image rotation processing 320. Additionally or alternatively, the one or more digital images 314 can be cropped to focus on relevant microfluidic channels via image cropping processing 322. Additionally or alternatively, relevant microfluidic channels of the one or more digital images 314 can be localized via a channel identification process 324. Additionally or alternatively, the one or more digital images 314 can be normalized and/or brightness of one or more portions of the one or more digital holography images can be adjusted via normalization processing 326. As such, the image pre-processing 305 can process the one or more digital images 314 to generate one or more pre-processed digital images 330 that correspond to a pre-processed version of the one or more digital images 314.

After the image reconstruction process 301 and/or the image pre-processing 305, the image assessment process 306 can be applied to the one or more pre-processed digital images 330 to assess each microfluidic channel of the one or more microfluidic channels 104. In some embodiments, presence of blood cells in the one or more pre-processed digital images 330 can be identified via blood cell presence identification 332 based on how bright or dark a microfluidic channel appears in the one or more pre-processed digital images 330. In some embodiments, a defined threshold can be utilized to determine how bright or dark a microfluidic channel appears in the one or more pre-processed digital images 330. In some embodiments, movement in the one or more pre-processed digital images 330 can be determined via movement identification 334. For example, movement can be determined based on how the one or more pre-processed digital images 330 change from one image frame to a successive image frame. In some embodiments, movement in the one or more pre-processed digital images 330 can be determined based on a frame-to-frame correlation coefficient image generated using a sliding window (e.g., a 5×5 pixel sliding window).

In some embodiments, an occlusion criteria process 336 can determine an occlusion status 340 based on the one or more pre-processed digital images 330. For example, the occlusion criteria process 336 can calculate a global average per resulting image associated with the blood cell presence identification 332 and/or the movement identification 334. In some embodiments, the global average can be compared to a defined threshold. The occlusion status 340 can provide an occlusion status for each microfluidic channel of the one or more microfluidic channels 104. In some embodiments, the occlusion status 340 can be determined based on a defined threshold related to the presence of blood cells and/or a defined threshold related to the movement. In some embodiments, a report related to a health status of a patient associated with the occlusion device can be generated based on the occlusion status 340.

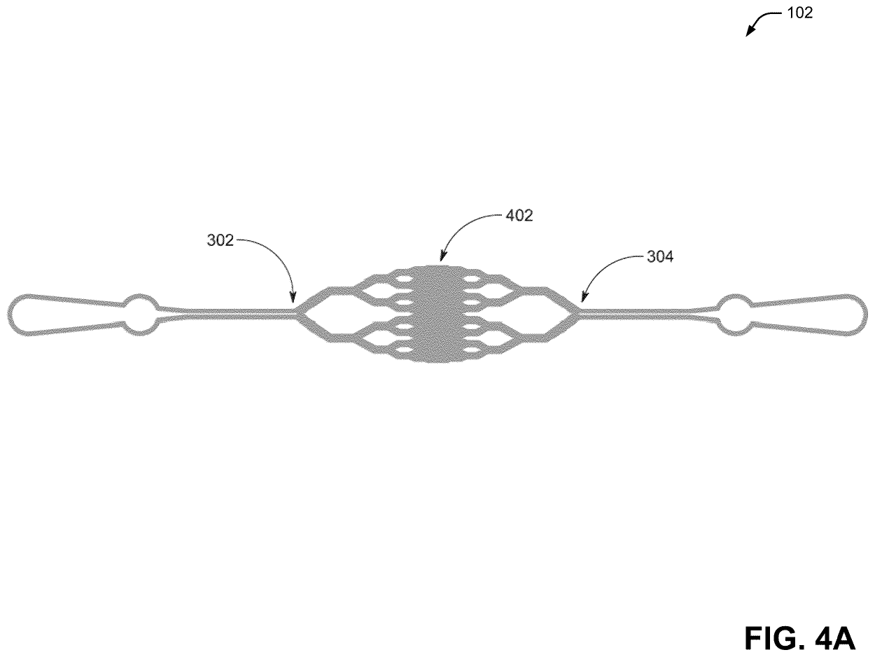

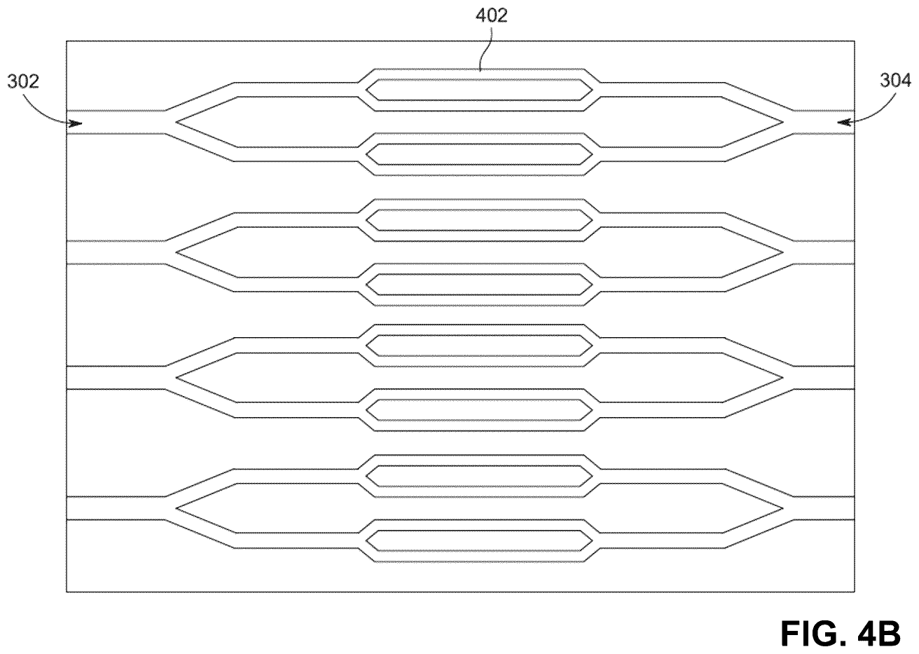

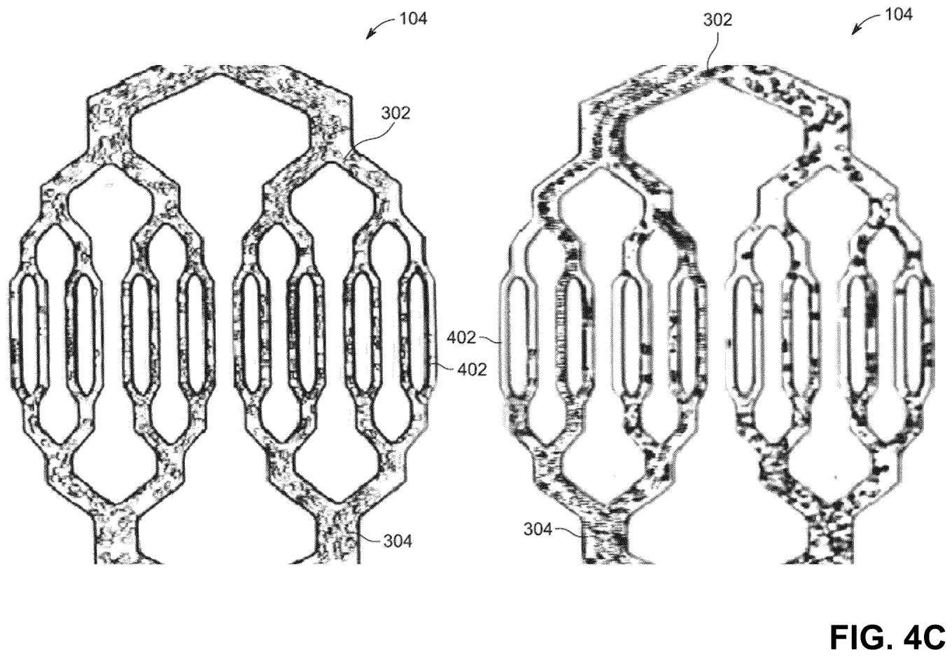

In some embodiments, the one or more microfluidic channels 104 associated with the one or more digital holography images 310, the one or more digital images 314, and/or the one or more pre-processed digital images 330 may comprise multiple dimensions at various points. In some embodiments, the one or more microfluidic channels 104 captured by the one or more digital holography images 310, the one or more digital images 314, and/or the one or more pre-processed digital images 330 may be included in the occlusion device 102. In some embodiments, each of the one or more microfluidic channels 104 of the occlusion device 102 may have at least one inlet and an outlet. In some embodiments, the one or more microfluidic channels 104 may have a branched structure 402, as illustrated in FIG. 4A, between at least one inlet 302 and an outlet 304. The one or more microfluidic channels 104 may have a predefined cross-sectional area at the various points across the branched structure 402. The one or more microfluidic channels 104 may be configured to facilitate flow of the plurality of blood cells of the blood sample within the interior surface of the one or more microfluidic channels 104. It may be noted that the plurality of blood cells may pass from the at least one inlet 302 to the outlet 304 via the branched structure 402. The branched structure 402 may have a small cross-section as compared to the at least one inlet 302.

In some example embodiments, the one or more microfluidic channels 104 may have dimensions of 30×30 micrometer (μm) that may be sufficiently large to permit the dynamic interaction of RBCs, WBCs, platelets, and other blood components that together form occlusions. In some embodiments, the blood sample cells may flow with a flow rate. In one example, the flow rate may include a flow rate of approximately 1 μL/minute. In some embodiments, a constant pressure instead of a constant flow rate may be used. Stated differently, a healthy blood may flow between the at least one inlet 302 and the outlet 304 in a suitable time frame without forming clots or getting occluded in the branched structure 402. The suitable time frame may correspond to few seconds or several minutes depending upon the flow velocity of the blood sample. In some example embodiments, a microfluidic channel may have one or more dimensions such as width and length in micrometer (μm) 30×500, 43×300, and 61×300, and height 30 micrometer. It will be apparent to one skilled in the art that the above-mentioned dimensions have been provided only for illustration purposes, without departing from the scope of the disclosure.

FIG. 4C illustrates an example of microscopy images of a normal blood sample and a hematologic diseased sample occluded within the one or more microfluidic channels 104, in accordance with an example embodiment of the present disclosure. FIG. 4C is described in conjunction with FIGS. 4A-4B.

As illustrated in FIG. 4C, a normal blood sample may easily flow between the at least one inlet 302 towards the outlet 304, via the branched structure 402. The plurality of blood cells, i.e., the blood cells in the normal blood sample may not occlude or clot within the branched structure 402. Further, the SCD blood sample when perfused from the at least one inlet 302 may be occluded or may clot within the branched structure 402. As discussed above, the one or more digital holography images captured by the at least one imager 108 may confirm occlusion of the SCD blood sample within the branched structure 402 of the one or more microfluidic channels 104.

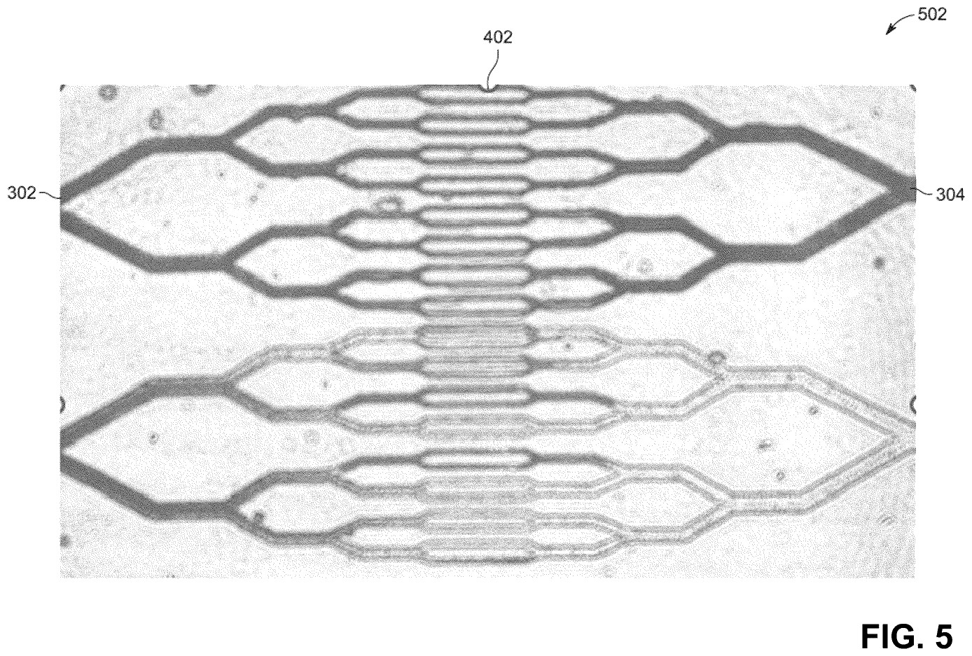

FIG. 5 illustrates an example holographic microscopy image 502 with blood sample cells flowing from the at least one inlet 302 to the outlet 304 of the one or more microfluidic channels 104, in accordance with an example embodiment of the present disclosure. The holographic microscopy image 502 may be an example image, holography image, digital holography microscopic image, or other type of image provided via digital holographic microscopy. FIG. 5 is described in conjunction with FIGS. 4A-4C.

The one or more microfluidic channels 104 may be analyzed by the holographic microscopic image 502 of the suitable time frame, for the normal blood sample and the SCD blood sample, as illustrated in FIG. 4C. In one example, the at least one imager 108 may capture a video showing flow of blood sample from the at least one inlet 302 towards the outlet 304. In another example, the at least one imager 108 may capture one or more images within the suitable time frame showing flow of blood sample from the at least one inlet 302 towards the outlet 304. It will be apparent that the flow of the blood sample from the at least one inlet 302 towards the outlet 304 varies according to the severity of the blood sample. The SCD blood sample may get occluded within the branched structure 402, while the normal blood sample may pass easily towards the outlet 304, as illustrated in FIG. 4C.

As discussed, the at least one processor 110 may be configured to analyze the generated one or more holography images or videos using the AI/ML module 114 to detect the presence of occluded microfluidic channels 104. Further, the quantification and/or characterization of the occluded microfluidic channels 104 may be configured to generate a score or relative indicator of the health status and/or indicate the efficacy of the medical treatment of the subject based on the severity of a hematologic disease in the plurality of blood cells.

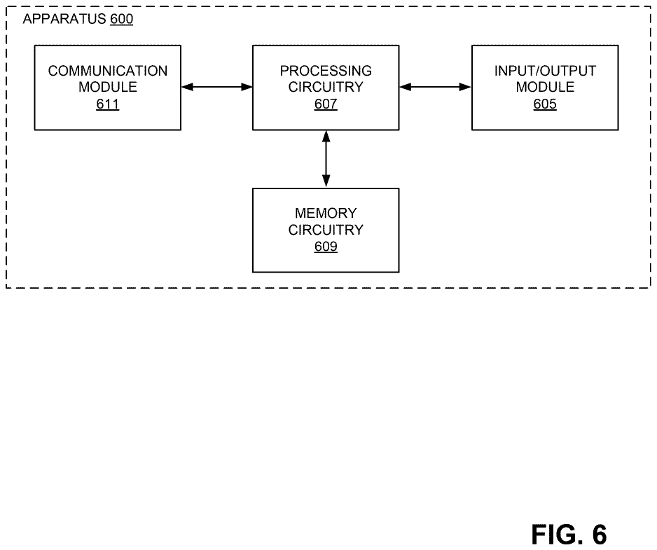

Referring now to FIG. 6, an example apparatus 600 in accordance with various embodiments of the present disclosure is provided. In particular, the example apparatus 600 includes input/output module 605, processing circuitry 607, memory circuitry 609, and communications circuitry 611. In some embodiments, the apparatus 600 is electrically coupled to and/or in electronic communication with the imaging device 106, the AI/ML module 114, and/or the network 116. In various embodiments, the input/output module 605, the processing circuitry 607, the memory circuitry 609, and/or the communications circuitry 611 may be electrically coupled to enable transmission and/or exchange of information and data via wired or wireless connections between and among one another.

As used herein, the term “processing circuitry” refers to a circuitry or circuitries that may be configured to perform processing functions and/or software instructions on one or more input signals to generate one or more output signals. In various embodiments of the present disclosure, the processing circuitry 607 may perform processing functions and/or software instructions on signals that are received from the at least one imager 108 (e.g., the digital holographic imager). In some embodiments, the processing circuitry 607 may correspond to the processor 110.

In some embodiments, the processing circuitry 607 may be implemented as, for example, various devices comprising one or a plurality of microprocessors with accompanying digital signal processors; one or a plurality of processors without accompanying digital signal processors; one or a plurality of coprocessors; one or a plurality of multi-core processors; one or a plurality of controllers; processing circuits; one or a plurality of computers; and various other processing elements (including integrated circuits, such as ASICs or FPGAs, or a certain combination thereof). In some embodiments, the processing circuitry 607 may comprise one or more processors. In one exemplary embodiment, the processing circuitry 607 is configured to execute instructions stored in the memory circuitry 609 or otherwise accessible by the processing circuitry 607. When executed by the processing circuitry 607, these instructions may enable the apparatus 600 to execute one or a plurality of the functions as described herein. No matter whether it is configured by hardware, firmware/software methods, or a combination thereof, the processing circuitry 607 may comprise entities capable of executing operations according to the embodiments of the present invention when correspondingly configured. Therefore, for example, when the processing circuitry 607 is implemented as an ASIC, an FPGA, or the like, the processing circuitry 607 may comprise specially configured hardware for implementing one or a plurality of operations described herein. In these examples, the ASIC is an integrated circuit that may be customized for processing signals. In some examples, the ASIC may be fully customized or semi-customized for the particular application of processing signals. In some examples, the ASIC may be a programmable ASIC that allows circuit reconfiguration. In some embodiments, other suitable forms of the processing circuitry 607 may be implemented. Alternatively, as another example, when the processing circuitry 607 is implemented as an actuator of instructions (such as those that may be stored in the memory circuitry 609), the instructions may specifically configure the processing circuitry 607 to execute one or a plurality of algorithms and operations described herein, such as those discussed with reference to FIG. 6.

Referring back to FIG. 6, the processing circuitry 607 may be electronically coupled to the input/output module 605, memory circuitry 609 and/or the communications circuitry 611. The memory circuitry 609 may be non-transitory and may include, for example, one or more volatile and/or non-volatile memories. The memory circuitry 609 may be configured to store information and data (such as processing functions and/or software instructions). The memory circuitry 609, together with the processing circuitry 607, may cause the apparatus 600 to perform various processing functions and/or software instructions in accordance with example embodiments of the present disclosure, including, for example, determining flow occlusion in microfluidics using digital holography. In some embodiments, the memory circuitry 609 may comprise, for example, a volatile memory, a non-volatile memory, or a certain combination thereof. Although illustrated as a single memory in FIG. 6, the memory circuitry 609 may comprise a plurality of memory components. In various embodiments, the memory circuitry 609 may comprise, for example, a hard disk drive, a random access memory, a cache memory, a flash memory, a Compact Disc Read-Only Memory (CD-ROM), a Digital Versatile Disk Read-Only Memory (DVD-ROM), an optical disk, a circuit configured to store information, or a certain combination thereof.

The memory circuitry 609 may be configured to store information, data, application programs, instructions, and etc., so that the apparatus 600 can execute various functions according to the embodiments of the present disclosure. For example, in at least some embodiments, the memory circuitry 609 is configured to cache input data for processing by the processing circuitry 607. Additionally or alternatively, in at least some embodiments, the memory circuitry 609 is configured to store program instructions for execution by the processing circuitry 607. The memory circuitry 609 may store information in the form of static and/or dynamic information. When the functions are executed, the stored information may be stored and/or used by the apparatus 600.

The communications circuitry 611 may comprise, for example, a device or circuitry embodied in either hardware or a combination of hardware and software that is configured to receive and/or transmit data from/to a network and/or any other device, circuitry, or module in communication with the apparatus 600 and/or the sensing element 601. In this regard, the communications circuitry 611 may include, for example, a network interface for enabling communications with a wired or wireless communication network. In some embodiments, the communications circuitry 611 may be implemented as any apparatus included in a circuit, hardware, a computer program product or a combination thereof, which is configured to receive and/or transmit data from/to another component or apparatus. The computer program product comprises computer-readable program instructions stored on a computer-readable medium (for example, the memory circuitry 609) and executed by the apparatus 600 (for example, the processing circuitry 607). In some embodiments, the communications circuitry 611 (as with other components discussed herein) may be at least partially implemented as the processing circuitry 607 or otherwise controlled by the processing circuitry 607. In this regard, the communications circuitry 611 may communicate with the processing circuitry 607, for example, through a bus. The communications circuitry 611 may comprise, for example, antennas, transmitters, receivers, transceivers, network interface cards and/or supporting hardware and/or firmware/software, and is used for establishing communication with another apparatus. The communications circuitry 611 may be configured to receive and/or transmit any data that may be stored by the memory circuitry 609 by using any protocol that can be used for communication between apparatuses. The communications circuitry 611 may additionally or alternatively communicate with the input/output module 605, memory circuitry 609, and/or any other component of the apparatus 600, for example, through a bus.

In some embodiments, the apparatus 600 may comprise an input/output module 605. The input/output module 605 may communicate with the processing circuitry 607 to receive instructions input by the user and/or to provide audible, visual, mechanical or other outputs to the user. Therefore, the input/output module 605 may comprise supporting devices, such as a keyboard, a mouse, a display, a touch screen display, and/or other input/output mechanisms. Alternatively, at least some aspects of the input/output module 605 may be implemented on a device used by the user to communicate with the apparatus 600. The input/output module 605 may communicate with the memory circuitry 609, the communications circuitry 611 and/or any other component, for example, through a bus. One or a plurality of input/output modules and/or other components may be included in the apparatus 600.

In FIG. 6, although components 601, 605, 607, 609, and 611 may be described with respect to functional limitations, it is contemplated that the particular implementations necessarily include the use of particular hardware. It is also contemplated that certain of these components 601, 605, 607, 609, and 611 may additionally include one or more similar or common hardware. For example, the sensing element 601 may additionally include a processing circuitry, such that the sensing element 601 may detect and process various signals. In various examples, the apparatus 600 may operate to generate measurements indicating a flow rate of a flowing media within the sensing element 601.

While the description above provides an example apparatus 600, it is noted that the scope of the present disclosure is not limited to the description above. In some examples, an example controller component may comprise one or more additional and/or alternative elements, and/or may be structured/positioned differently than that illustrated in FIG. 6.

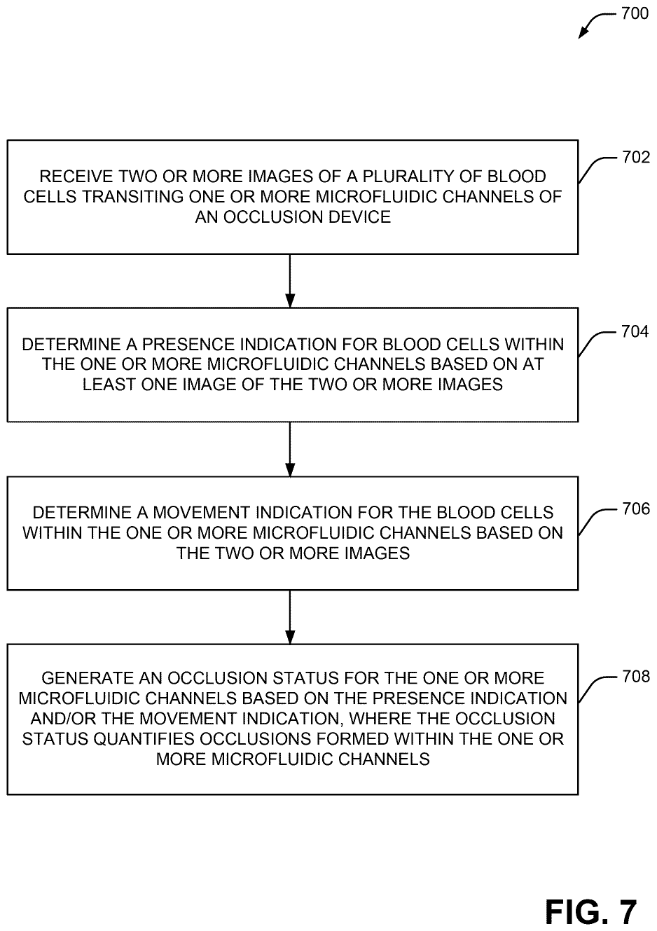

FIG. 7 illustrates a method 700 for determining flow occlusion in microfluidics using digital holography in accordance with one or more embodiments described herein. In one or more embodiments, method 700 may be a computer-implemented method. The method 700 may be executed and/or performed by the processing circuitry 607, for example. In some embodiments, the method 700 may be executed and/or performed by the imaging device 106 (e.g., the processor 110) and/or the AI/ML module 114. In some embodiments, the method 700 may be executed and/or performed by an apparatus (e.g., the apparatus 600) communicatively coupled to the imaging device 106 via the network 116. For example, in some embodiments, the method 700 may be executed and/or performed by an apparatus (e.g., the apparatus 600) communicatively coupled to and/or integrated with a network device, a cloud computing platform, and/or another device. In one or more embodiments, the method 700 begins with receiving two or more images of a plurality of blood cells transiting one or more microfluidic channels of an occlusion device (block 702). In one or more embodiments, the one or more microfluidic channels comprise a predefined cross-sectional area and/or other predefined dimensionality associated with microvasculature blood vessels. In one or more embodiments, the plurality of blood cells are unstained and untagged. In one or more embodiments, the method 700 additionally or alternatively includes determining a presence indication for blood cells within the one or more microfluidic channels based on at least one image of the two or more images (block 704). For example, in some embodiments, a presence indication for blood cells within the one or more microfluidic channels may be determined based on one of the two or more images. In other embodiments, a presence indication for blood cells within the one or more microfluidic channels may be determined based on both the two or more images.

In one or more embodiments, the method 700 additionally or alternatively includes determining a movement indication for the blood cells within the one or more microfluidic channels based on the two or more images (block 706).

In one or more embodiments, the method 700 additionally or alternatively includes generating an occlusion status for the one or more microfluidic channels based on the presence indication and/or the movement indication, where the occlusion status quantifies occlusions formed within the one or more microfluidic channels (block 708).

In one or more embodiments, the method 700 additionally or alternatively includes capturing the two or more images via digital holographic microscopy.

In one or more embodiments, the method 700 additionally or alternatively includes generating two or more phase images associated with reconstructed phase data based on the two or more images. In one or more embodiments, the method 700 additionally or alternatively includes determining the movement indication for the blood cells within the one or more microfluidic channels based on the two or more phase images.

In one or more embodiments, the method 700 additionally or alternatively includes generating two or more amplitude images associated with reconstructed amplitude data based on the two or more images. In one or more embodiments, the method 700 additionally or alternatively includes determining the movement indication for the blood cells within the one or more microfluidic channels based on the two or more amplitude images.

In one or more embodiments, the method 700 additionally or alternatively includes generating two or more phase images associated with reconstructed phase data based on the two or more images. In one or more embodiments, the method 700 additionally or alternatively includes generating two or more amplitude images associated with reconstructed amplitude data based on the two or more images. In one or more embodiments, the method 700 additionally or alternatively includes determining the movement indication for the blood cells within the one or more microfluidic channels based on the two or more phase images and the two or more amplitude images.

In one or more embodiments, the method 700 additionally or alternatively includes generating at least one phase image associated with reconstructed phase data based on at least one image of the two or more images. In one or more embodiments, the method 700 additionally or alternatively includes determining the presence indication for the blood cells within the one or more microfluidic channels based on the at least one phase image.

In one or more embodiments, the method 700 additionally or alternatively includes generating at least one amplitude image associated with reconstructed amplitude data based on at least one image of the two or more images. In one or more embodiments, the method 700 additionally or alternatively includes determining the presence indication for the blood cells within the one or more microfluidic channels based on the at least one amplitude image.

In one or more embodiments, the method 700 additionally or alternatively includes generating at least one phase image associated with reconstructed phase data based on at least one image of the two or more images. In one or more embodiments, the method 700 additionally or alternatively includes generating at least one amplitude image associated with reconstructed amplitude data based on at least one image of the two or more images. In one or more embodiments, the method 700 additionally or alternatively includes determining the presence indication for the blood cells within the one or more microfluidic channels based on the at least one phase image and the at least one amplitude image.

In one or more embodiments, the method 700 additionally or alternatively includes generating a rendering of a visualization for a user interface based on the occlusion status.

In one or more embodiments, the method 700 additionally or alternatively includes generating a health status notification associated the plurality of blood cells based on the occlusion status.

In one or more embodiments, the method 700 additionally or alternatively includes determining an efficacy score for a medical treatment associated with the plurality of blood cells based on the occlusion status.

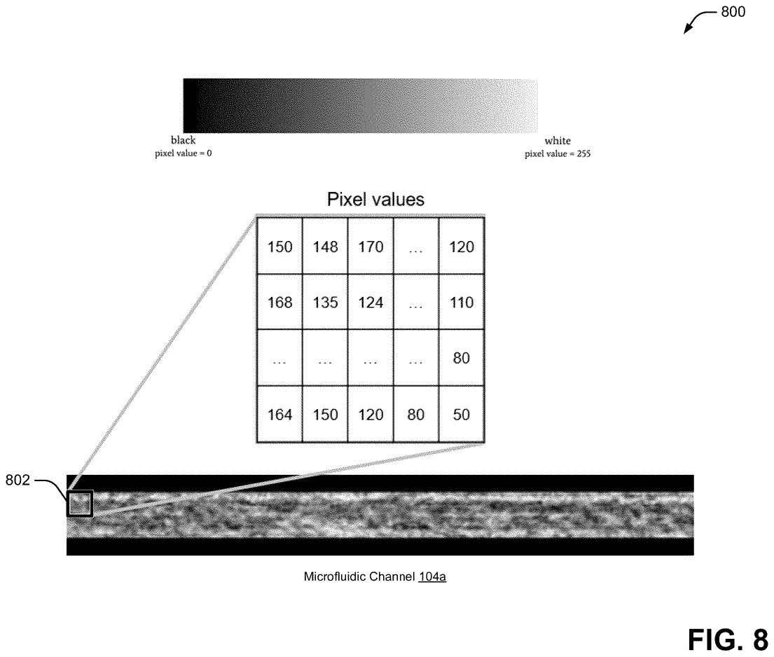

FIG. 8 illustrates an exemplary data flow 800 for determining an intensity measure associated with blood cell presence identification, in accordance with an example embodiment of the present disclosure. In some embodiments, the data flow 800 can be associated with the blood cell presence identification 332 of the image assessment process 306. The data flow 800 includes imagery associated with a microfluidic channel 104a. In some embodiments, a pixel portion 802 of an image associated with the microfluidic channel 104a can include a set of pixel values with various intensities. For example, the intensities can be related to darkness (e.g., a degree of darkness for a pixel) for respective pixels of the pixel portion 802 to determine how bright or dark a respective portion of the microfluidic channel 104a appears in the image. The image can correspond to a digital holography image of the one or more digital holography images 310, a digital image of the one or more digital images 314, or a pre-processed digital image of the one or more pre-processed digital images 330. In some embodiments, intensity I of a microfluidic channel (e.g., the microfluidic channel 104a) can be determined based on the following equation:

$$I = \frac{\sum F ( A )}{n}$$

where A corresponds to a matrix of pixel values (e.g., the pixel portion 802), F(A) corresponds to a flatten matric (e.g., two-dimensional to one-dimensional), and n corresponds to a number of pixels in F(A). In some embodiments, the intensity measure can represent a presence indication for blood cells within the microfluidic channel (e.g., the microfluidic channel 104a).

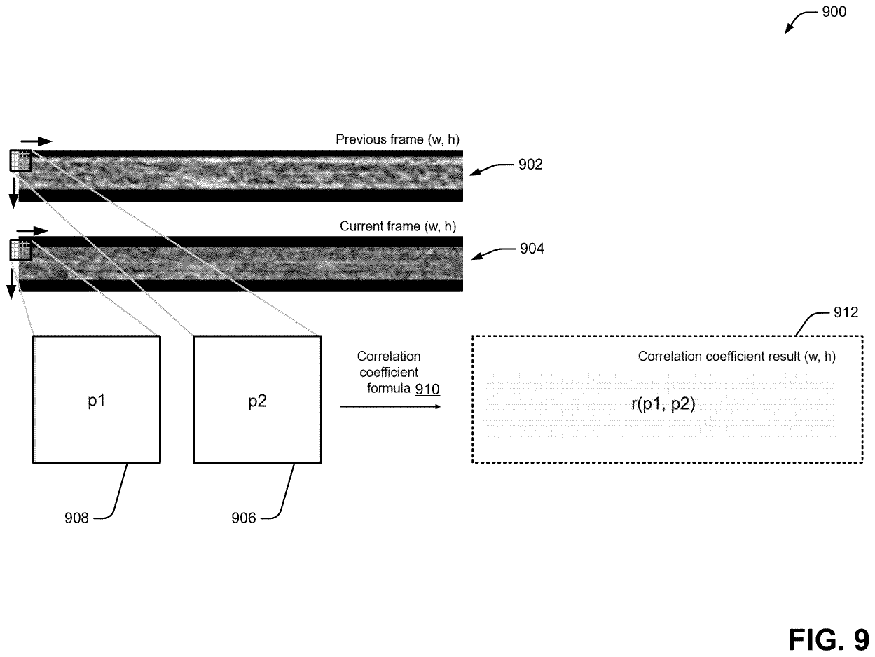

FIG. 9 illustrates an exemplary data flow 900 for determining a correlation coefficient associated with movement identification, in accordance with an example embodiment of the present disclosure. In some embodiments, the data flow 900 can be associated with the movement identification 334 of the image assessment process 306. The data flow 900 includes an image 902 and an image 904 associated with a microfluidic channel of the one or more microfluidic channels 104. For example, the image 902 can correspond to a previous image frame associated with a microfluidic channel and the image 902 can correspond to a current image frame associated with the microfluidic channel. In some embodiments, the image 902 can correspond to a first image of the one or more digital holography images 310, the one or more digital images 314, or the one or more pre-processed digital images 330. Additionally, the image 902 can correspond to a second image of the one or more digital holography images 310, the one or more digital images 314, or the one or more pre-processed digital images 330. The data flow 900 also includes a pixel portion 906 (e.g., p2) of the image 902 and a pixel portion 908 (e.g., p1) of the image 904. The pixel portion 906 can include a first set of pixel values and the pixel portion 908 can include a second set of pixel values. In some embodiments, a correlation coefficient formula 910 can be utilized to provide a correlation coefficient result 912 associated with movement between the image 902 and the image 904. In some embodiments, the movement can represent a movement indication for blood cells within the microfluidic channel associated with the image 902 and the image 904. In some embodiments, the correlation coefficient formula 910 (e.g., r(p1, p2)) can correspond to the following formula:

$$r ( p 1 , p 2 ) = \frac{{\sum }_{i = 1}^{n} [ ( p {1}_{i} - \overline{p 1} ) * ( p {2}_{i} - \overline{p 2} ) ]}{n ( {σ}_{p 1} * {σ}_{p 2} )}$$

where p1 corresponds to the pixel portion 908 (e.g., a first patch of pixels), p2 corresponds to the pixel portion 906 (e.g., a second patch of pixel with a same size as p1), p̅1̅ corresponds to a mean value of p1, p̅2̅ corresponds to a mean value of p2, σ corresponds to a standard deviation of a pixel portion (e.g., a patch of pixels), and n corresponds to a number of pixels in p1 or p2.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising one or more processors and one or more storage devices storing instructions that are operable, when executed by the one or more processors, to cause the one or more processors to:
receive two or more images of a plurality of blood cells transiting one or more microfluidic channels of an occlusion device;
determine a presence indication for blood cells within the one or more microfluidic channels based on at least one image of the two or more images;
determine a movement indication for the blood cells within the one or more microfluidic channels based on the two or more images; and
generate an occlusion status for the one or more microfluidic channels based on (i) the presence indication and (ii) the movement indication, wherein the occlusion status quantifies occlusions formed within the one or more microfluidic channels.

2. The apparatus of claim 1, wherein the one or more storage devices store instructions are operable, when executed by the one or more processors, to further cause the one or more processors to:
capture the two or more images via digital holographic microscopy.

3. The apparatus of claim 2, wherein the one or more storage devices store instructions are operable, when executed by the one or more processors, to further cause the one or more processors to:
generate two or more phase images associated with reconstructed phase data based on the two or more images; and
determine the movement indication for the blood cells within the one or more microfluidic channels based on the two or more phase images.

4. The apparatus of claim 2, wherein the one or more storage devices store instructions are operable, when executed by the one or more processors, to further cause the one or more processors to:
generate two or more amplitude images associated with reconstructed amplitude data based on the two or more images; and
determine the movement indication for the blood cells within the one or more microfluidic channels based on the two or more amplitude images.

5. The apparatus of claim 2, wherein the one or more storage devices store instructions are operable, when executed by the one or more processors, to further cause the one or more processors to:
generate two or more phase images associated with reconstructed phase data based on the two or more images;
generate two or more amplitude images associated with reconstructed amplitude data based on the two or more images; and
determine the movement indication for the blood cells within the one or more microfluidic channels based on the two or more phase images and the two or more amplitude images.

6. The apparatus of claim 2, wherein the one or more storage devices store instructions are operable, when executed by the one or more processors, to further cause the one or more processors to:
generate at least one phase image associated with reconstructed phase data based on at least one image of the two or more images; and
determine the presence indication for the blood cells within the one or more microfluidic channels based on the at least one phase image.

7. The apparatus of claim 2, wherein the one or more storage devices store instructions are operable, when executed by the one or more processors, to further cause the one or more processors to:
generate at least one amplitude image associated with reconstructed amplitude data based on at least one image of the two or more images; and
determine the presence indication for the blood cells within the one or more microfluidic channels based on the at least one amplitude image.

8. The apparatus of claim 2, wherein the one or more storage devices store instructions are operable, when executed by the one or more processors, to further cause the one or more processors to:
generate at least one phase image associated with reconstructed phase data based on at least one image of the two or more images;
generate at least one amplitude image associated with reconstructed amplitude data based on at least one image of the two or more images; and
determine the presence indication for the blood cells within the one or more microfluidic channels based on the at least one phase image and the at least one amplitude image.

9. The apparatus of claim 1, wherein the one or more storage devices store instructions are operable, when executed by the one or more processors, to further cause the one or more processors to:
generate a rendering of a visualization for a user interface based on the occlusion status.

10. The apparatus of claim 1, wherein the one or more storage devices store instructions are operable, when executed by the one or more processors, to further cause the one or more processors to:
generate a health status notification associated the plurality of blood cells based on the occlusion status.

11. The apparatus of claim 1, wherein the one or more storage devices store instructions are operable, when executed by the one or more processors, to further cause the one or more processors to:
determine an efficacy score for a medical treatment associated with the plurality of blood cells based on the occlusion status.

12. The apparatus of claim 1, wherein the one or more microfluidic channels comprise a predefined cross-sectional area associated with microvasculature blood vessels.

13. A computer-implemented method, comprising:
receiving two or more images of a plurality of blood cells transiting one or more microfluidic channels of an occlusion device;
determining a presence indication for blood cells within the one or more microfluidic channels based on at least one image of the two or more images;
determining a movement indication for the blood cells within the one or more microfluidic channels based on the two or more images; and
generating an occlusion status for the one or more microfluidic channels based on (i) the presence indication and (ii) the movement indication, wherein the occlusion status quantifies occlusions formed within the one or more microfluidic channels.

14. The computer-implemented method of claim 13, further comprising:
capturing the two or more images via digital holographic microscopy;
generating two or more phase images associated with reconstructed phase data based on the two or more images; and
determining the movement indication for the blood cells within the one or more microfluidic channels based on the two or more phase images.

15. The computer-implemented method of claim 13, further comprising:
capturing the two or more images via digital holographic microscopy;
generating two or more amplitude images associated with reconstructed amplitude data based on the two or more images; and
determining the movement indication for the blood cells within the one or more microfluidic channels based on the two or more amplitude images.

16. The computer-implemented method of claim 13, further comprising:
capturing the two or more images via digital holographic microscopy;
generating two or more phase images associated with reconstructed phase data based on the two or more images;
generating two or more amplitude images associated with reconstructed amplitude data based on the two or more images; and
determining the movement indication for the blood cells within the one or more microfluidic channels based on the two or more phase images and the two or more amplitude images.

17. The computer-implemented method of claim 13, further comprising:
capturing the two or more images via digital holographic microscopy;
generating at least one phase image associated with reconstructed phase data based on at least one image of the two or more images; and
determining the presence indication for the blood cells within the one or more microfluidic channels based on the at least one phase image.

18. The computer-implemented method of claim 13, further comprising:
capturing the two or more images via digital holographic microscopy;
generating at least one amplitude image associated with reconstructed amplitude data based on at least one image of the two or more images; and
determining the presence indication for the blood cells within the one or more microfluidic channels based on the at least one amplitude image.

19. The computer-implemented method of claim 13, further comprising:
capturing the two or more images via digital holographic microscopy;
generating at least one phase image associated with reconstructed phase data based on at least one image of the two or more images;
generating at least one amplitude image associated with reconstructed amplitude data based on at least one image of the two or more images; and
determining the presence indication for the blood cells within the one or more microfluidic channels based on the at least one phase image and the at least one amplitude image.

20. A computer program product comprising at least one non-transitory computer readable storage medium having computer executable code portions stored therein, the computer executable code portions comprising program code instructions configured to:
receive two or more images of a plurality of blood cells transiting one or more microfluidic channels of an occlusion device;
determine a presence indication for blood cells within the one or more microfluidic channels based on at least one image of the two or more images;
determine a movement indication for the blood cells within the one or more microfluidic channels based on the two or more images; and
generate an occlusion status for the one or more microfluidic channels based on (i) the presence indication and (ii) the movement indication, wherein the occlusion status quantifies occlusions formed within the one or more microfluidic channels.
